(19) United States
(12) Patent Application Publication
(10) Pub. No.: US 2010/0224473 A1
(43) Pub. Date: Sep. 9, 2010

(54) MULTI-FUNCTION SWITCH STRUCTURE

(75) Inventor: Peter Andrew Jeffery, Huntington Beach, CA (US)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/716,851

(22) Filed: Mar. 3, 2010

Related U.S. Application Data
(60) Provisional application No. 61/156,912, filed on Mar. 3, 2009.

(51) Int. Cl. H01H 1/10

(52) U.S. Cl. 200/512

(57) ABSTRACT

A switch has multiple movable contacts, such as snap domes, positioned in a stacked relationship with each other. The stacked relationship may be such that the apexes of each dome point in the same orientation, or the apexes may be in an opposite orientation so that they point toward or away from each other. When the switch is initially depressed, one of the contacts forms a first electrical connection. When the switch is further depressed, a second one of the contacts forms a second electrical connection. Alternatively, multiple moveable contacts are positioned on the same plane under a single bubble of a carrier sheet. Multiple actuating elements may depress each of the domes. Adjacent domes may share common conductive traces.

### RELATED APPLICATION AND CLAIM OF PRIORITY

This application claims the priority of U.S. Provisional Application No. 61/156,912, titled “Multi-Function Switch Structure,” filed Mar. 3, 2009, the contents of which is hereby incorporated by reference in its entirety.

NOT APPLICABLE

### BACKGROUND

Membrane switch structures are used on many electronic devices, such as telephones, personal digital assistants, and portable computing devices. In small electronic devices, a dome switch or snap dome may be positioned under each key of the device's keypad so that when a key is depressed, the dome is also depressed. FIG. 1 illustrates a portion of a prior art membrane switch assembly 10 such as the type used in mobile phones. Pairs of contacts 12, 14 are positioned at spaced locations on a circuit board 16. A snap dome 20 is positioned over each pair of contacts, with the periphery 22 of each snap dome lying on and in constant contact with the outer contact 12. The middle 24 of each snap dome is positioned over a middle contact 14 and touches the middle contact 14 when the snap dome is depressed. This causes the middle contact 14 to engage the outer contact 12. Although a non-snap dome may be used, a snap dome is often used because it provides tactile feedback to the person who depresses it. The upper surfaces of the domes 20 may be adhesively fastened to a flexible carrier sheet 30 which are used to hold the domes 20 in selected positions over the pairs of contacts.

A manually depressable key 32 may have an identification marking 34 on its upper surface. The key 32 has a transparent or translucent downward projection 36. When the key 32 is depressed, the projection 36 depresses a location on the carrier sheet 30, which depresses the middle 24 of the dome 20 to cause contacts 12 and 14 to close the switch that corresponds to that key. When the depressing force is no longer applied, the dome, a portion of the carrier sheet 30 and the key 32 revert to their original positions. A light guide 40 may be mounted above the carrier sheet and have a hole 42 aligned with the carrier sheet portion that is positioned above a dome. The key projection 36 projects through the hole 42. The light guide carries light from a light source and releases some of the light at the hole 42, to pass through and around the projection to illuminate the key.

FIG. 2 is a sectional view of a switch of the assembly of FIG. 1. The membrane switch includes a spacer 50 and two adhesive layers 52, 54 that hold the carrier sheet 30 so that it is raised above the circuit board 16 to allow venting of air beneath the dome, and to hold the carrier sheet in place on the circuit board. Lines 61-63 show the paths of light passing from the light source 64 along the light guide 40. The light guide may be fastened by screws to the circuit board or held down by the device housing. FIG. 2 depicts the dome 20 in its quiescent position. Line 20A shows the dome in a depressed or activated position.

Traditional dome switch structures are limited in their functionality. As electronic devices become smaller, it is desirable that individual keys have multiple functions. This document describes switch structures that help provide multiple functions to individual keys.

### SUMMARY

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

A switch has multiple movable contacts, such as snap domes, positioned in a stacked relationship with each other. The stacked relationship may be such that the apexes of each dome point in the same orientation, or the apexes may be in an opposite orientation so that they point toward or away from each other. When the switch is initially depressed, one of the contacts forms a first electrical connection. When the switch is further depressed, a second one of the contacts forms a second electrical connection.

In an alternate embodiment, multiple moveable contacts are positioned on the same plane under a single bubble of a carrier sheet. Multiple actuating elements may depress each of the domes. Adjacent domes may share common conductive traces.

### BRIEF DESCRIPTION OF THE DRAWINGS

FIG. 1 illustrates a portion of a prior art membrane switch assembly.

FIG. 2 depicts a sectional view of a switch of the assembly of FIG. 1.

FIG. 3 illustrates a first embodiment of an exemplary multi-function switch.

FIG. 4 illustrates a second embodiment of a multi-function switch.

FIG. 5 illustrates a third embodiment of a multi-function switch.

FIG. 6 illustrates a fourth embodiment of a multi-function switch.

FIG. 7 illustrates a fifth embodiment of a multi-function switch.

### DETAILED DESCRIPTION

For purposes of the discussion below, the term “adhesive” refers to a compound that binds one object to a second object, either permanently or in a manner that will allow the objects to be separated upon application of an appropriate force.

The term “light guide” refers to a sheet of material that receives light from an external source, propagates light from the point of entry throughout the sheet, and distributes light so that light is provided over the surface area of the sheet.

The terms “positioned over” and “positioned under” define a location based relationship between two objects. The term “positioned over” includes positioned above, positioned next to, and positioned below. Similarly, the term “positioned under” includes positioned above, positioned next to, and positioned below. For example, if item X has object A positioned above object B, object A is still positioned above object B if item X is turned upside down or if item X is turned on its side.

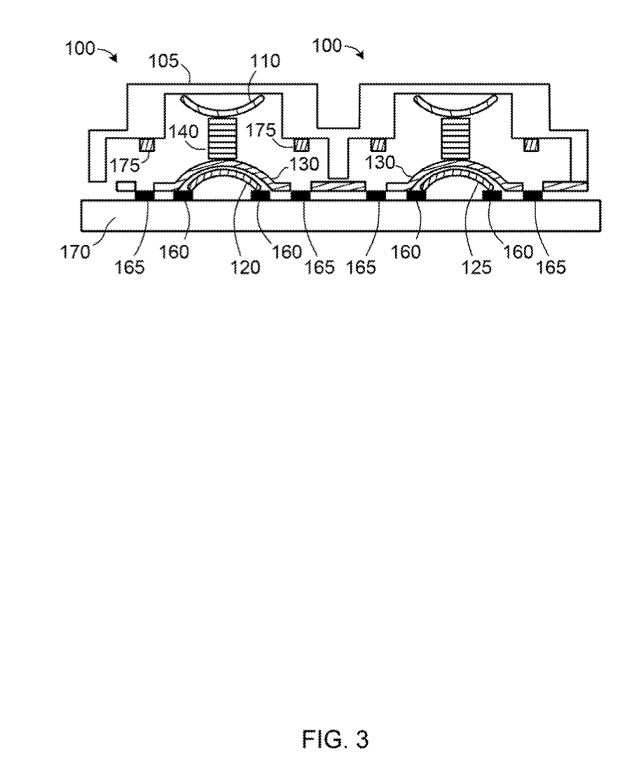

FIG. 3 depicts a sectional view of two adjacent exemplary switch structures 100 according to an embodiment. Each switch structure includes a switch cover 105 such as a key, display screen, touch pad, or other structure that may be depressed by a user. The structure also includes an upper deformable element 110 and a lower deformable element 120. When the deformable elements are snap domes, as illustrated in FIG. 3, the upper movable element or dome 110 may be positioned in a concave position with respect to the switch cover so that the apex of the upper dome points away from the cover, while the lower deformable element or dome 120 may be positioned in a convex position with respect to the switch cover so that the apex of the lower dome points toward the cover. Other configurations and positions are possible so long as an upper deformable element and lower deformable element are present.

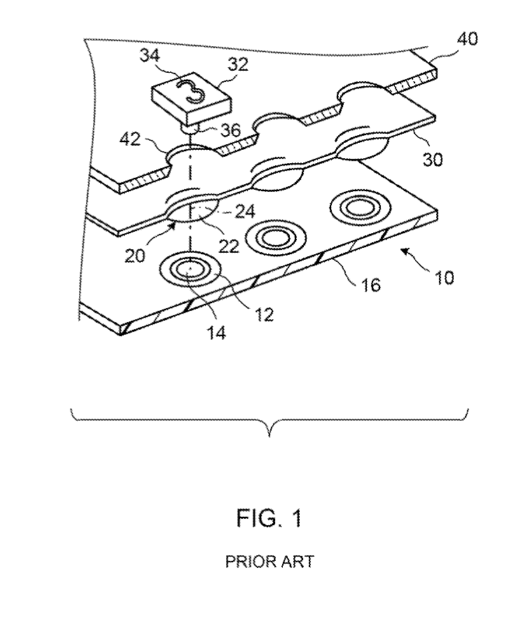

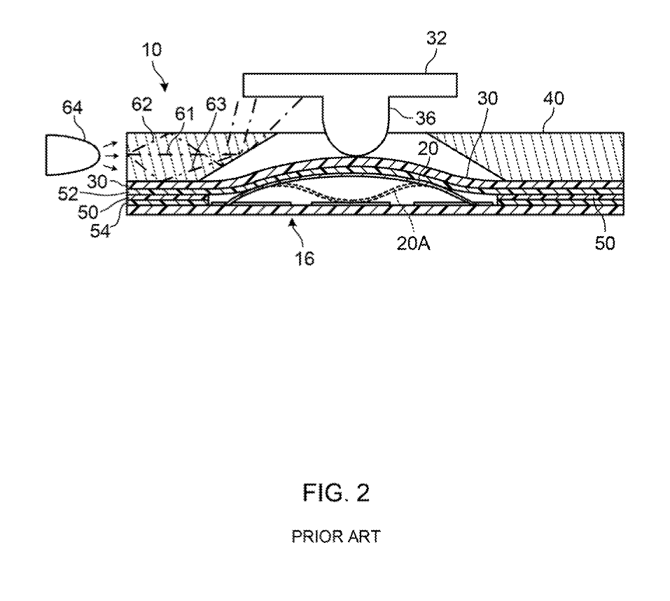

A flexible carrier sheet 130 is positioned above the lower dome 120. Lower dome 120 is adhered to carrier sheet 130 using any suitable adhesive. Carrier sheet 130 and multiple lower domes 120, 125, etc. may together make up a dome sheet that is used in an electronic device. In some embodiments, carrier sheet 130 may be a light guide made up of a flexible material such as polycarbonate. Optionally, instead of or in addition to carrier sheet 130, a flexible damping structure (not shown) may be placed over the apex of lower dome 120 or carrier sheet 130 to provide additional damping properties. Optionally, although not shown in FIG. 1, an additional carrier sheet and/or damping structure may be positioned under the apex of upper dome 110.

When each deformable element is depressed (i.e., deformed), it forms an electrical path that triggers an action caused by actuation of the switch. As shown in FIG. 3, the lower domes 120, 125 may be positioned over a substrate 170 on which multiple traces 160, 165 of conductive ink, carbon paste pads, or other material are provided. When lower dome 120 (or 125) is depressed, the metal of the dome may create a first electrical path that includes the dome and a first trace or set of traces 160. The first path is normally open when the lower contact is not depressed.

Similar traces or conductive elements may be positioned above or below upper dome 110. Alternatively, as shown in FIG. 3 a second trace or set of traces 165 may be positioned on the substrate 170 underneath a lateral contact or set of conductive contacts 175 that extend from the switch cover and move downward to touch the second traces 165 so that the lateral contact(s) 175 and second traces 165 form a second electrical path. In the embodiment shown in FIG. 3, the lateral contact(s) may be either deformable or rigid, and they may include multiple elements or a single element such as a conductive ring. The gap between the lateral contacts 175 and second traces 165 may be sufficient so that that the electrical connection of lateral contacts 175 and second traces 165 only occurs after the lower dome 120 has been fully depressed to form the first electrical path with the first traces 160.

In some embodiments, instead of a substrate and printed traces, a printed circuit board may be positioned under the lower deformable element and/or over the upper deformable element.

A spacer structure 140 may be positioned between the upper dome 110 and the lower dome 120. Spacer structure 140 may be made of a rigid or semi-rigid material such a silicone rubber or a polymeric material such as an elastomer so that when the switch cover is depressed, upper dome 110 is moved downward, which in turn moves spacer 140 downward, which in turn depresses lower dome 120. In some embodiments, the spacer structure 140 may be made of a material that is rigid and substantially incompressible, such as a material having a Durometer hardness greater than or equal to 95 Shore A. In other embodiments, the spacer structure 140 may be compressible, such as a material having a Durometer hardness less than 95 Shore A. In some embodiments, the spacer structure 140 may have a rebound resilience greater than or equal to 60%. In other embodiments, the spacer structure 140 may have a rebound resilience less than 60%. In various embodiments, the spacer structure 140 may have a damping factor less than 0.2, from 0.2 to 0.4, from 0.4 to 0.6, or greater than 0.6.

Upper dome 110 and lower dome 120 may, in some embodiments, be made of the same material. In other embodiments, the domes may have slightly different resilient properties and/or thicknesses so that pressing the switch cover 105 will cause one of the domes to deform before the other dome deforms. For example, lightly pressing the switch cover may cause the lower dome 120 to deform and create the first electrical path, and then continued pressing of the cover or application of additional force to the cover may cause the upper dome 120 to deform and create the second electrical path that includes contacts 175 and traces 165.

In various embodiments, additional domes or other deformable elements may be stacked in a vertical relationship with the upper dome 110 and lower dome 120 shown in FIG. 3.

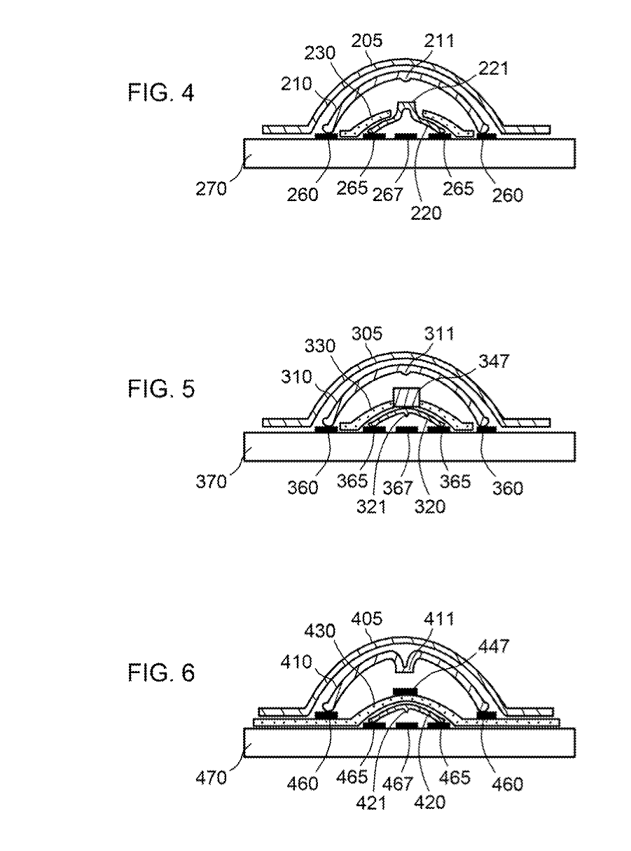

In an embodiment, when the deformable elements 110 and 120 are snap domes, the domes may be made of stainless steel, although other materials are possible. The domes may be of various sizes depending on the required size for the electronic device. For example, the domes may have an approximate diameter of 5 mm, 4 mm, 3 mm, 2 mm, +/−10% of these sizes, or other sizes, in some embodiments. These sizes and materials also may apply to the domes of the embodiments shown in FIGS. 4-7.

FIG. 4 illustrates an alternate embodiment that includes two deformable elements 210 and 220 positioned in a stacked relationship so that both are oriented with their apexes facing away from the substrate 270. As shown in FIG. 4, the deformable elements may be snap domes made of stainless steel or another conductive material. The upper dome 210 is adhered to an upper carrier sheet 205, and the lower dome is adhered to a lower carrier sheet 230. The lower dome may include a protruding element that extends upward through an opening in the lower carrier sheet 230. Upper dome 210 may normally contact outer traces 260 on the substrate. Lower dome 220 may normally contact inner traces 265 on the substrate. A central trace 267 may be positioned under the apex of the lower dome so that lower trace 267 does not contact either dome when the switch is not depressed.

When force is applied to the top of the switch, such as by the depression of a key, display, switch housing or other structure, the upper dome 210 will flex downward so that the approximate center of the upper dome 210 contacts the protruding element 221 of the lower dome 220. Optionally, the lower surface of upper dome 210 may include one or more dimples or protrusions to facilitate an electrical connection between upper dome 210 and the protruding element 221 of lower dome 220. When this occurs, a first electrical circuit may be formed to include upper dome 210, outer traces 260, lower dome 220, and inner traces 265. When the switch is further depressed, lower dome 220 will flex downward so that a central area of lower dome 220 contacts the central trace 267. When this occurs, a second electrical circuit may be formed to include central trace 267 and the elements of the first circuit.

FIG. 5 illustrates an alternate embodiment that includes two deformable elements 310 and 320 positioned in a stacked relationship so that both are oriented with their apexes facing away from the substrate 370. As with other embodiments, the deformable elements may be snap domes made of stainless steel or another conductive material. The upper dome 310 is adhered to an upper carrier sheet 305, and the lower dome is adhered to a lower carrier sheet 330. Upper dome 310 may normally contact outer traces 360 on the substrate. Lower dome 320 may normally contact inner traces 365 on the substrate. A central trace 367 may be positioned under the apex of the lower dome so that lower trace 367 does not contact either dome when the switch is not depressed. A conductive pad 347, such as a carbon paste pad, is positioned on top of or extending upward through the lower carrier sheet 330.

When force is applied to the top of the switch, such as by the depression of a key, display, switch housing or other structure, the upper dome 310 will flex downward so that the approximate center of the upper dome 310 contacts the carbon pad 347, which in turn contacts lower dome 320. Optionally, the lower surface of upper dome 310 may include one or more dimples or protrusions 311 to facilitate an electrical connection between upper dome 310 and the carbon pad 347. When this occurs, a first electrical circuit may be formed to include upper dome 310, outer traces 360, carbon pad 347, lower dome 320, and inner traces 365. When the switch is further depressed, lower dome 320 will flex downward so that a central area of lower dome 320 contacts the central trace 367. When this occurs, a second electrical circuit may be formed to include central trace 367 and the elements of the first circuit. Optionally, the lower surface of lower dome 330 may include one or more dimples or protrusions 321 to facilitate an electrical connection between lower dome 320 and the central trace 367.

FIG. 6 illustrates an alternate embodiment that includes two deformable elements 410 and 420 positioned in a stacked relationship so that both are oriented with their apexes facing away from the substrate 470. As with other embodiments, the deformable elements may be snap domes made of stainless steel or another conductive material. The upper dome 410 is adhered to an upper carrier sheet 405, and the lower dome is adhered to a lower carrier sheet 430. Lower carrier sheet includes outer conductive traces positioned on an upper surface. Upper dome 410 may normally contact outer traces 460 on the lower carrier sheet. Lower dome 420 may normally contact inner traces 465 that are positioned on the substrate. A lower central trace 467 may be positioned on the substrate under the apex of the lower dome so that lower trace 467 does not contact either dome when the switch is not depressed. An upper central conductive trace 447 is positioned on top of the lower carrier sheet 430 and under the apex of the upper dome so that upper central trace 447 does not contact either dome when the switch is not depressed.

When force is applied to the top of the switch, such as by the depression of a key, display, switch housing or other structure, the upper dome 410 will flex downward so that the approximate center of the upper dome 410 contacts the upper central trace 447 and forms a first electrical circuit. Optionally, the lower surface of upper dome 410 may include one or more dimples or protrusions 411 to facilitate an electrical connection between upper dome 410 and the upper central trace 447. When this occurs, a first electrical circuit may be formed to include upper dome 410, outer traces 460, and the upper central trace 447. When the switch is further depressed, lower dome 420 will flex downward so that a central area of lower dome 420 contacts the central trace 467. When this occurs, a second electrical circuit may be formed to include lower central trace 467, lower dome 420, and the inner traces 465. Optionally, the underside surface of lower dome 430 may include one or more dimples or protrusions 421 to facilitate an electrical connection between lower dome 420 and the lower central trace 467.

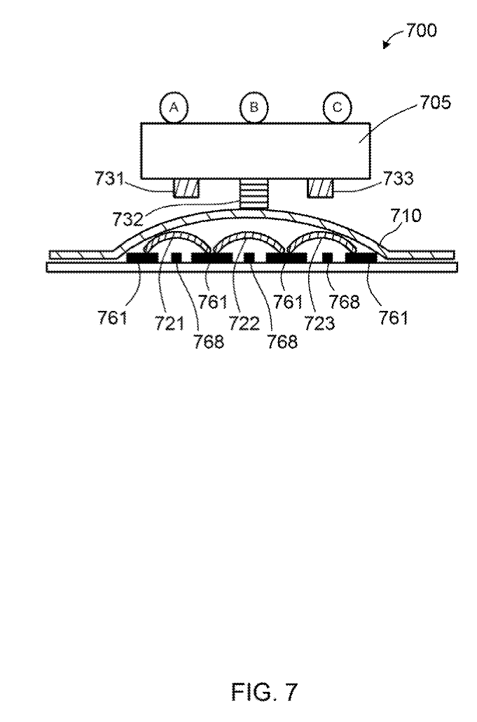

FIG. 7 illustrates an alternate multi-function switch 700 that includes a key element 705 that includes multiple actuating projections of differing lengths. Key element 705 may be a key such as is present in a keypad, or it may be a display, touch screen, touch-sensitive pad, or other structure. Under the key element 705 is a flexible dome sheet 710 that in some embodiments may serve as a light guide, or which in other embodiments merely may serve as a support or damping structure. Positioned under and optionally adhered to a single bubble of the dome sheet 710 and over a substrate 770 are a plurality of deformable elements 721, 722, 723, such as elastic domes made of stainless steel or another resilient material. Adjacent domes may be adhered to the carrier sheet, and they may share an electrical connection with one or more conductive traces 761.

Any number of deformable elements may be provided, and they are all placed on the same plane over the substrate. Each deformable element is positioned under one of the actuating members 731, 732, 733 of the key structure 705. When the key structure is pressed at various locations, the actuating members under the area where the force is applied will move downward and depress its corresponding dome to close an electrical circuit. Each dome is electrically connected to at least one outer trace 761, and each dome includes a corresponding inner trace 768 that is positioned under and at the approximate center of the dome.

In operation, when the key element 705 is depressed at position A, actuating member 731 will move downward, depress dome 721, and cause dome 721 to contact its corresponding inner trace 768. Similarly, when the key element 705 is depressed at position B, actuating member 732 will move downward, depress dome 722, and cause dome 722 to contact its corresponding inner trace 768. Similarly, when the key element 705 is depressed at position C, actuating member 733 will move downward, depress dome 723, and cause dome 723 to contact its corresponding inner trace 768. Optionally, the actuating members may have differing lengths, with the inner actuating member 732 having a length greater than that of the outer actuating members 731 and 733, to allow for rocking action of the switch at positions A and C about position B.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art.

What is claimed is:

1. A switch, comprising:
a switch cover;
an upper deformable element positioned under the switch cover;
a spacer positioned under the upper deformable element;
a lower deformable element positioned under the spacer; and
a substrate positioned under the lower deformable element;
wherein the deformable elements are positioned so that application of a first force level to the switch cover causes the lower deformable element to deform and become part of a first electrical path with a first conductive trace on the substrate, and application of a second force level to the switch cover causes the formation of a second electrical path.

2. The switch of claim 1, wherein the second electrical path comprises a lateral contact and a second conductive trace on the substrate, and the application of the second force level causes the lateral contact to move downward and contact the second conductive trace.

3. The switch of claim 1, wherein the spacer comprises a material having a Durometer hardness greater than or equal to 95 Shore A.

4. The switch of claim 1, wherein the spacer comprises a material having a Durometer hardness less than 95 Shore A.

5. The switch of claim 1, wherein the spacer comprises a material having a rebound resilience of greater than 60%.

6. The switch of claim 1, wherein the spacer comprises a material having a rebound resilience of less than 60%.

7. The switch of claim 1, wherein the spacer is comprised of a material having a damping factor that is greater than 0.6.

8. The switch of claim 1, wherein the spacer is comprised of a material having a damping factor that is from 0.4 to 0.6.

9. The switch of claim 1, wherein the spacer is comprised of a material having a damping factor that is less than or equal to 0.2.

10. A switch comprising:
an upper snap dome positioned over and concentrically with a lower snap dome;
a flexible, non-conductive sheet positioned between the upper dome and the lower dome;
a substrate positioned under the lower dome;
a first conductive trace set positioned on the substrate to contact and form a first electrical circuit with the upper dome; and
a second conductive trace set positioned on the substrate to contact and form a second electrical circuit with the lower dome;
wherein the domes are positioned so that when the upper dome is depressed, the upper dome forms a third electrical circuit with the second dome.

11. A switch comprising:
an upper snap dome positioned over and concentrically with a lower snap dome;
a flexible, non-conductive sheet positioned between the upper dome and the lower dome; and
a substrate positioned under the lower dome;
a first conductive trace set positioned; and
a second conductive trace set positioned on the substrate to contact and form a second electrical circuit with the lower dome;
wherein the domes are positioned so that when the upper dome is depressed, the upper dome forms a first electrical circuit with the first conductive trace set, and when the upper dome is further depressed the second dome forms a second electrical circuit with the second conductive trace set.

12. A switch comprising:
a carrier sheet;
a plurality of deformable elements positioned under a single bubble of the carrier sheet;
a key element positioned over the carrier sheet, the key element having a plurality of actuating members positioned so that an actuating member is positioned over each of the deformable elements;
a substrate positioned under the deformable elements, the substrate having a plurality of outer conductive traces on an upper surface positioned to contact the deformable elements at all times, and the substrate also having a plurality of inner conductive traces positioned on the upper surface to contact any of the deformable elements only when force is applied to an actuating member that is positioned over the deformable element that covers the inner trace.
